(19) United States
(12) Patent Application Publication
(10) Pub. No.: US 2008/0031200 A1
(43) Pub. Date: Feb. 7, 2008

(54) WLAN DEVICE AND METHOD FOR NUMBERING FRAMES WITH SEQUENCE NUMBERS

(75) Inventor: CHENG-WEN TANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/306,466

(22) Filed: Dec. 29, 2005

(30) Foreign Application Priority Data
Aug. 26, 2005 (TW) 94129242

(51) Int. Cl. H04Q 7/00; H04L 12/28

(52) U.S. Cl. 370/338; 370/394

(57) ABSTRACT

A method for numbering a plurality of frames with sequence numbers, implemented in a wireless network having a plurality of data units, includes steps of: providing receiver addresses and transmit rates of the data units; and numbering each data unit with a respective sequence number according to the receiver address and the transmit rate of the data unit. A WLAN (wireless local area network) device employing the method is also provided. When the WLAN device transmits data to a receiving device, the receiving device can employ the method to compute Frame Error Rates (FERs) of the WLAN device at different transmit rates.

### FIELD OF THE INVENTION

The invention relates to wireless communication devices, and particularly to a WLAN (wireless local area network) device and method for numbering frames with sequence numbers.

### DESCRIPTION OF RELATED ART

The specification of the Institute of Electrical and Electronics Engineers (IEEE) known as 802.11 defines the structure of Media Access Control (MAC) frames including data frames, management frames and control frames. FIG. 1 and FIG. 2 respectively show representations of an IEEE 802.11 MAC data frame 100 and an IEEE 802.11 MAC management frame 200. The data frame 100 and the management frame 200 respectively include sequence control fields 160, 260. The sequence control fields 160, 260 respectively include segment number subfields 161, 261 and sequence number subfields 162, 262. The sequence number subfields 162, 262 are fields indicating the sequence numbers of MAC Service Management Data Units (MSDUs) or MAC Management Protocol Data Units (MMPDUs). Each MSDU or MMPDU is assigned a sequence number, ranging from 0 to 4095.

In a conventional method, a transmitting device assigns sequence numbers from a single modulo 4096 counter, starting at 0 and incrementing by 1 for each MSDU or MMPDU regardless of transmit rates. The transmitting device transmits three MAC frames at different transmit rates. The management frames and the control frames are transmitted at a basic transmit rate, while the data frames are transmitted at the fastest transmit rate supported by the transmitting device.

When the transmitting device transmits a frame to a receiving device, the transmitting device computes a Frame Error Rate (FER) according to whether the receiving device replies by way of Acknowledgement (ACK) signals transmitted to the transmitting device, and the transmitting device adjusts its transmit rate according to the FER. However, the transmitting device cannot compute the FER according to ACK signals in the following two circumstances.

In a first circumstance, when the transmitting device transmits broadcast frames and management frames to the receiving device, the frames do not require reply by way of ACK signals transmitted from the receiving device to the transmitting device. Therefore, the transmitting device cannot determine whether the receiving device has received the transmitted frames.

In a second circumstance, when the transmitting device supports No-Acknowledge (No-ACK) and transmits frames to the receiving device, the receiving device does not need to reply by way of transmitting ACK signals to the transmitting device.

Therefore in the above two circumstances, the transmitting device cannot compute its FER according to whether the receiving device replies by way of transmitting ACK signals. Moreover, the receiving device cannot compute the FERs of the transmitting device at different transmit rates.

### SUMMARY OF INVENTION

An exemplary embodiment of the present invention provides a WLAN (wireless local area network) device for transmitting data units. The WLAN device includes a Media Access Control (MAC) layer protocol module. The MAC layer protocol module is used for numbering the data units with sequence numbers. Each data unit includes a receiver address and a transmit rate. The MAC layer protocol module includes a list module and a numbering module. The list module is used for providing the transmit rate of each data unit according to the receiver address of the data unit. The numbering module is used for numbering each data unit with a respective sequence number according to the receiver address and the transmit rate of the data unit.

Another exemplary embodiment of the present invention provides a method for numbering a plurality of frames with sequences numbers. The method is implemented in a wireless network having a plurality of data units, and includes the steps of: providing receiver addresses and transmit rates of the data units; and numbering each data unit with a respective sequence number according to the receiver address and the transmit rate of the data unit.

Other advantages and novel features will become more apparent from the following detailed description when taken in conjunction with the accompanying drawings, in which:

### BRIEF DESCRIPTION OF DRAWINGS

FIG. 1 is a schematic diagram of an IEEE 802.11 MAC data frame format;

FIG. 2 is a schematic diagram of an IEEE 802.11 MAC management frame format;

FIG. 3 is a schematic diagram of an exemplary application environment of any of various exemplary embodiments of the present invention, including a WLAN device according to any of various exemplary embodiments of the present invention;

FIG. 4 is a block diagram of functional modules of a WLAN device of an exemplary embodiment of the present invention;

FIG. 5 is a flowchart of data processing in accordance with another exemplary embodiment of the present invention;

FIG. 6 is a flowchart of a method for numbering frames with sequence numbers in accordance with still another exemplary embodiment of the present invention; and

FIG. 7 is a block diagram of functional modules of a WLAN device of yet another exemplary embodiment of the present invention.

### DETAILED DESCRIPTION

The Open Systems Interconnection Reference Model (OSI Reference Model or OSI Model for short) is a layered description for communications and computer network protocol design, developed as part of the Open Systems Interconnect initiative. The OSI Reference Model is also called the OSI seven layer model. The first layer of the OSI model is a Physical layer, and the Physical layer defines all electrical and physical specifications for devices. The second layer of the OSI model is a Data Link layer, and the Data Link layer provides the functional and procedural means to transfer data between network entities and to detect and possibly correct errors that may occur in the Physical layer. The Data Link layer is composed of two sublayers: a Media Access Control (MAC) layer and a Logical Link Control (LLC) layer. The third layer of the OSI model is a Network layer, and the Network layer provides the functional and procedural means of transferring variable length data sequences from a source to a destination via one or more networks while maintaining the quality of service requested by a Transport layer. The fourth layer of the OSI model is the Transport layer, and the purpose of the Transport layer is to provide transfer of data between end users, thus relieving the upper layers from any concern with providing reliable and cost-effective data transfer. The fifth layer of the OSI model is a Session layer, and the Session layer provides the mechanism for managing the dialogue between end-user application processes. The sixth layer of the OSI model is a Presentation layer, and the Presentation layer relieves the Application layer of concern regarding syntactical differences in data representation within the end-user systems. The highest or the seventh layer of the OSI model is an Application layer, and the Application layer interfaces directly to and performs common application services for the end-user application processes.

IEEE 802.11 defines specifications of the Physical layer and the MAC layer, and the specifications allow wireless 802.11 WLAN devices to communicate with each other.

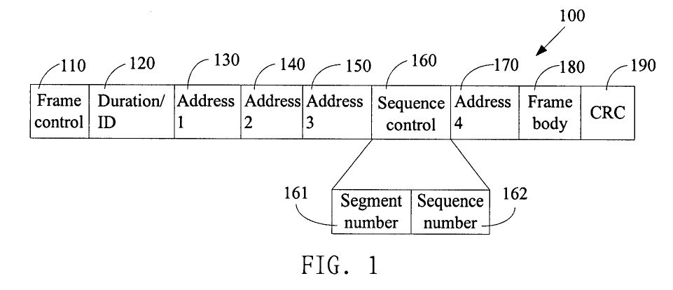

FIG. 1 is a schematic diagram of an IEEE 802.11 MAC data frame format. The MAC data frame 100 includes a frame control field 110, a duration/ID field 120, an address 1 field 130, an address 2 field 140, an address 3 field 150, a sequence control field 160, an address 4 field 170, a frame body field 180, and a CRC (cyclic redundancy check) field 190. The sequence control field 160 includes a segment number subfield 161 and a sequence number subfield 162.

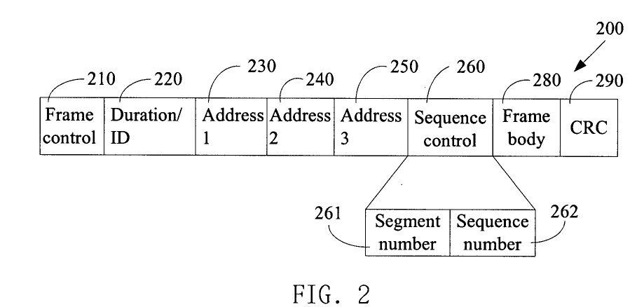

FIG. 2 is a schematic diagram of an IEEE 802.11 MAC management frame format. The MAC management frame 200 includes a frame control field 210, a duration/ID field 220, an address 1 field 230, an address 2 field 240, an address 3 field 250, a sequence control field 260, a frame body field 280, and a CRC field 290. The sequence control field 260 includes a segment number subfield 261 and a sequence number subfield 262.

As shown in FIG. 1 and FIG. 2, the address 1 fields 131, 231 indicate receiver addresses of the frames, namely the receiver addresses of MAC service data units (MSDUs) and MAC management protocol data units (MMPDUs). Each receiver address has 48 bits, different receiver addresses indicate different receivers, and the broadcast address is indicated by “FF: FF: FF: FF: FF”. The sequence control fields 160, 260 include the segment number subfields 161, 261, and the sequence number subfields 162, 262. The sequence number subfields 162, 262 include sequence numbers of MSDUs or MMPDUs of the frames. The frame body fields 180, 280 include the MSDUs from a higher layer and the MMPDUs generated in a MAC layer. Each MSDU or MMPDU is assigned a sequence number, ranging from 0 to 4095.

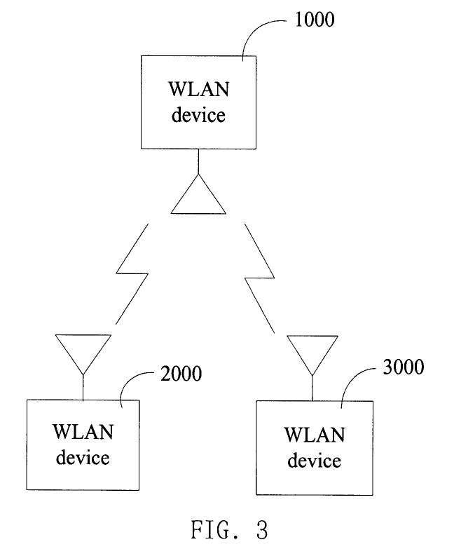

FIG. 3 is a schematic diagram of an exemplary application environment of any of various exemplary embodiments of the present invention, including a WLAN device according to any of various exemplary embodiments of the present invention. In the exemplary application environment, a wireless communication system includes a plurality of WLAN devices 1000, 2000 and 3000. The WLAN device 1000 transmits data to a plurality of WLAN devices 2000, 3000, and transmits broadcast data.

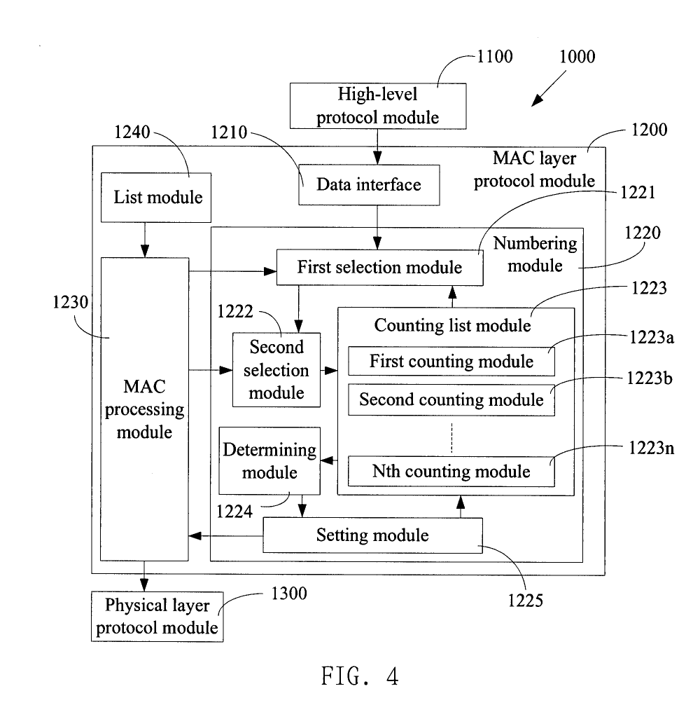

FIG. 4 is a block diagram of functional modules of the WLAN device 1000 of an exemplary embodiment of the present invention. In the exemplary embodiment, the WLAN device 1000 includes a high-level protocol module 1100, a MAC layer protocol module 1200, and a physical layer protocol module 1300. The high-level protocol module 1100 is used for providing a plurality of data units. In the exemplary embodiment, the high-level protocol module 1100 implements the functions of the Application layer, the Presentation layer, the Session layer, the Transport layer, the Network layer and the LLC layer, converts the transmitted data into MSDUs, and then transmits the MSDUs and transmit rates thereof to the MAC layer protocol module 1200. The MAC layer protocol module 1200 is used for generating a plurality of data units, and for numbering the data units provided by the high-level protocol module 1100 and the data units generated by the MAC layer protocol 1200 with sequence numbers. The MAC layer protocol module 1200 is also used for applying the sequence numbers to the data units, and for adding one or more information fields to the data units to form MAC protocol data units (MPDUs). The physical layer protocol module 1300 is used for generating physical layer protocol data units (PPDUs) by adding one or more other information fields to the MPDUs.

The MAC layer protocol module 1200 includes a data interface 1210, a numbering module 1220, a MAC processing module 1230, and a list module 1240. In an alternative exemplary embodiment, the MAC layer protocol module 1200 does not include the data interface 1210. The list module 1240 includes a receiver address and transmit rate list, and is used for providing the transmit rate of each data unit according to the receiver address of the data unit. In the exemplary embodiment, each data unit includes an MSDU or an MMPDU. The data interface 1210 is used for receiving the MSDUs and the receiver addresses thereof from the high-level protocol level 1100, and for transmitting the MSDUs and the receiver addresses thereof to the numbering module 1220. The MAC processing module 1230 is used for generating a plurality of data units. In the exemplary embodiment, the MAC processing module 1230 generates MMPDUs and receiver addresses thereof according to requirements of management, and transmits the MMPDUs and the receiver addresses thereof to the numbering module 1220. The MAC processing module 1230 is also used for providing the transmit rates of the data units to the numbering module 1220 according to the list module 1240.

The numbering module 1220 is used for numbering each data unit with a respective sequence number according to the receiver address and the transmit rate of the data unit. In the exemplary embodiment, the numbering module 1220 receives the MSDUs and the receiver addresses thereof from the data interface 1210, the MMPDUs and the receiver addresses thereof from the MAC processing module 1230, and the transmit rate of each data unit from the MAC processing module 1230, and then numbers the MSDUs and the MMPDUs in sequence according to the receiver addresses and the transmit rates.

The numbering module 1220 includes a first selection module 1221, a second selection module 1222, a counting list module 1223, a determining module 1224, and a setting module 1225. The counting list module 1223 includes a plurality of counting modules; i.e., a first counting module 1223a, a second counting module 1223b, and so on through to an Nth counting module 1223n. The first through Nth counting modules 1223a˜1223n are for numbering each data unit with a sequence number. The first selection module 1221 receives the data units, and selects at least one counting module from the counting list module 1223 respectively for each data unit according to the receiver address of the data unit. The counting modules selected by the first selection module 1221 number each one data unit having different transmit rates with a sequence number. In the exemplary embodiment, the first selection module 1221 receives the MSDUs and the receiver addresses thereof from the data interface 1210, and the MMPDUs and the receiver addresses thereof from the MAC processing module 1230, and then selects at least one counting module from the counting list module 1223 respectively for each data unit according to the receiver address of the data unit. The first selection module 1221 then informs the second selection module 1222 of the selected counting module(s). The second selection module 1222 selects one counting module from the counting modules selected by the first selection module 1221 respectively for each data unit according to the transmit rate of the data unit. The counting module is used for numbering the data unit with a sequence number. In the exemplary embodiment, the second selection module 1222 receives the transmit rate of each data unit provided by the MAC processing module 1230, and selects one counting module from the counting modules selected by the first selection module 1221 respectively for each data unit according to the transmit rate of the data unit.

The determining module 1224 is used for determining whether the sequence number numbered by the counting module is less than a predetermined threshold value. In the exemplary embodiment, the predetermined threshold value is 4096. The setting module 1225 is used for setting a sequence number to each data unit according to the result of the determination of the determining module 1224. In the exemplary embodiment, if the sequence number numbered by the counting module is less than the predetermined threshold value, the sequence number numbered by the counting module is set to the data unit; and if the sequence number numbered by the counting module is not less than the predetermined threshold value, a predetermined or default sequence number is set to the data unit. In the exemplary embodiment, the predetermined sequence number is 0. The setting module 1225 is also used for updating the counting list module 1223.

The MAC processing module 1230 is also used for applying the sequence numbers numbered by the numbering module 1220 to the data units, and for adding information fields to data units to form MPDUs. In the exemplary embodiment, the MAC processing module 1230 adds information fields to the MSDUs and the MMPDUs to form MPDUs, and applies the sequence numbers numbered by the numbering module 1220 to the sequence number subfields 162, 262 of the MPDUs (see FIG. 1 and FIG. 2).

The physical layer protocol module 1300 generates PPDUs by adding other information fields to the MPDUs formed by the MAC layer protocol module 1200, and then transmits the PPDUs.

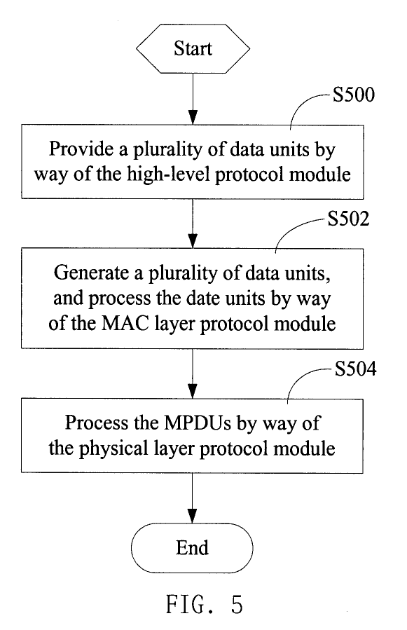

FIG. 5 is a flowchart of data processing implemented according to an exemplary embodiment of the WLAN device 1000. In the exemplary embodiment, when the WLAN device 1000 transmits data to a plurality of WLAN devices 2000, 3000, and transmits broadcast data, the transmitted data must be processed by a plurality of protocol layers of an OSI Model before transmitting.

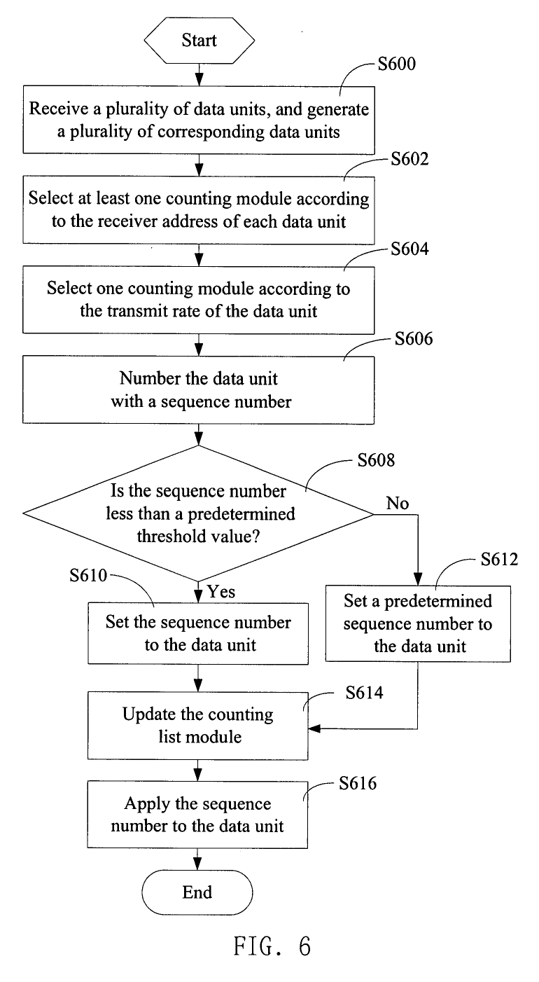

In step S500, the high-level protocol module 1100 provides a plurality of data units. In the exemplary embodiment, the high-level protocol module 1100 implements the functions of the Application layer, the Presentation layer, the Session layer, the Transport layer, the Network layer and the LLC layer, converts the transmitted data into MSDUs, and then transmits the MSDUs and transmit rates thereof to the MAC layer protocol module 1200. In step S502, the MAC layer protocol module 1200 generates a plurality of data units, and processes the data units provided by the high-level protocol module 1100 and the data units generated by the MAC layer protocol module 1200. In the exemplary embodiment, the MAC layer protocol module 1200 numbers the data units provided by the high-level protocol module 1100 and the data units generated by the MAC layer protocol 1200 with sequence numbers, applies the sequence numbers to the data units, and adds related information fields to the data units to form MPDUs. The method for numbering the data units by the MAC layer protocol module 1200 is described below in relation to FIG. 6. In step S504, the physical layer protocol module 1300 processes the MPDUs. In the exemplary embodiment, the physical layer protocol module 1300 generates physical layer protocol data units (PPDUs) by adding other related information fields to the MPDUs.

FIG. 6 is a flow chart of a method for numbering frames with sequence numbers according to an exemplary embodiment of the invention. In the exemplary embodiment, when the WLAN device 1000 transmits data units to a plurality of WLAN devices 2000, 3000, and transmits broadcast data units, each transmitted data unit must be numbered with a sequence number.

In step S600, the data interface 1210 receives a plurality of data units, and the MAC processing module 1230 generates a plurality of corresponding data units. In the exemplary embodiment, the data interface 1210 receives MSDUs and receiver addresses thereof from the high-level protocol module 1100, and then transmits the MSDUs and the receiver addresses thereof to the first selection module 1221 of the numbering module 1220. The MAC processing module 1230 generates MMPDUs and receiver addresses thereof according to requirements of management, and then transmits the MMPDUs and the receiver addresses thereof to the first selection module 1221 of the numbering module 1220.

In step S602, the first selection module 1221 receives the data units from the data interface 1210 and the MAC processing module 1230, and selects at least one counting module for numbering each data unit having different transmit rates with a sequence number according to the receiver address of the data unit. In the exemplary embodiment, the first selection module 1221 receives the MSDUs and the receiver addresses thereof from the data interface 1210, and the MMPDUs and the receiver addresses thereof from the MAC processing module 1230, and then selects at least one counting module from the counting list module 1223 according to the receiver address of the data unit. The amount of counting modules is determined by the amount of transmit rates of the data unit. In the exemplary embodiment, the receiver address of the data unit indicates that the data unit is transmitted to the WLAN device 2000 only. The WLAN devices 1000, 2000 each support 11 Mbps, 5.5 Mbps, 2 Mbps and 1 Mbps transmit rates. Therefore the first selection module 1221 selects four counting modules. In another exemplary embodiment, the WLAN devices 1000, 2000 may each support more transmit rates. Accordingly, the first selection module 1221 would select more counting modules.

In step S604, the MAC processing module 1230 provides a current transmit rate of the data unit to the second selection module 1222, and the second selection module 1222 selects one counting module from the counting modules selected by the first selection modules 1221 according to the transmit rate of the data unit. In the exemplary embodiment, the second selection module 1222 selects the first counting module 1223a.

In step S606, the first counting module 1223a numbers the data unit with a sequence number according to a predetermined function. In the exemplary embodiment, the function is F(x)=4x+1, wherein x is defined as the sequence of the data unit transmitted to the WLAN apparatus 2000 at a current transmit rate. Therefore, the sequence number of the first data unit transmitted to the WLAN apparatus 2000 at the current transmit rate is numbered 5, the sequence number of the second data unit is numbered 9, and so on. In other exemplary embodiments, the function may be another kind of linear function or another type of function.

In step S608, the determining module 1224 determines whether the sequence number numbered by the first count module 1223a is less than a predetermined threshold value. In the exemplary embodiment, the predetermined threshold value is 4096.

If the numbered sequence number is less than the predetermined threshold value, in step S610, the setting module 1225 sets the numbered sequence number to the data unit. In the exemplary embodiment, the received data unit is set to be the sequence number numbered by the first count module 1223a.

If the numbered sequence number is not less than the predetermined threshold value, in step S612, the setting module 1225 sets a predetermined sequence number to the data unit. In the exemplary embodiment, the predetermined sequence number is 0.

In step S614, the setting module 1225 updates the count modules of the counting list module 1223 according to the setting result of the setting module 1225, and transmits the data units, the receiver addresses and the set sequence numbers thereof to the MAC processing module 1230. In the exemplary embodiment, the setting module 1225 updates the first count module 1223a.

In step S616, the MAC processing module 1230 applies the sequence number to the data unit. In the exemplary embodiment, the MAC processing module 1230 receives the data unit, the receiver address and the sequence number thereof, adds related information fields to the data unit to form an MPDU, applies the sequence number to the sequence number subfield of the MPDU, and then transmits the MPDU to the physical layer protocol module 1300.

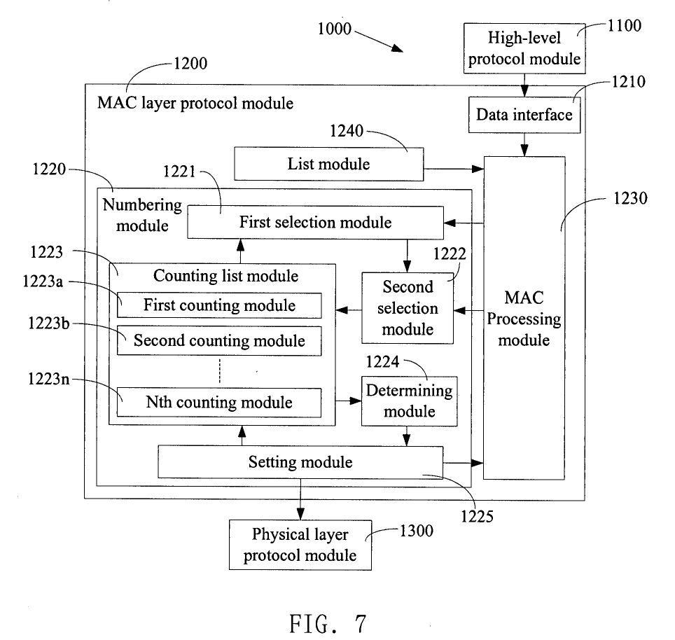

FIG. 7 is a block diagram of functional modules of a WLAN device of another exemplary embodiment of the invention. In the exemplary embodiment, the MAC processing module 1230 first receives MSDUs and receiver addresses thereof from the high-level protocol module 1100 via the data interface 1210, generates MMPDUs and receiver addresses according to requirements of management, adds related information fields to the MSDUs and MMPDUs to form MPDUs, and transmits the MPDUs to the numbering module 1220. In the exemplary embodiment, the added information fields include the sequence number subfield, and the numbering module 1220 updates the sequence number subfield of each MPDU. The numbering module 1220 then transmits the MPDUs to the physical protocol module 1300. The other functional components of this exemplary embodiment are the same as those described above in relation to FIG. 4.

In still another exemplary embodiment, the added information fields do not include the sequence number subfield, and the numbering module 1220 numbers each MPDU with a sequence number. The numbering module 1220 then transmits the numbered MPDUs to the physical protocol module 1300. The other functional components of this exemplary embodiment are the same as those described above in relation to FIG. 4.

The WLAN device of any of the above-described embodiments numbers each data unit with a respective sequence number according to the receiver address and the transmit rate of the data unit, applies the sequence numbers to MPDUs formed by the data units, and transmits the MPDUs to a receiving device. The receiving device can compute the amount of complete MPDUs according to the CRC fields 190, 290 (see FIGS. 1 and 2) of the MPDUs at different transmit rates, and compute the total amount of received MPDUs according to the sequence number subfields of the MPDUs at different transmit rates. The receiving device can compute Frame Error Rates (FERs) of the MPDUs at different transmit rates according to the following formula:

FER=(the amount of incomplete MPDUs)/(the total amount of MPDUs); that is, FER=(the total amount MPDUs−the amount of complete MPDUs)/(the total amount of MPDUs).

Therefore the receiving device can determine the result of the relationship between the transmit rates and the FERs of the transmitting device, whereupon the receiving device transmits the result to the transmitting device. The transmitting device receives the result, and adjusts its transmit rates according to the result. In the exemplary embodiment of FIG. 6, the numbering module 1220 applies the first counting module 1223a to number some data units with sequence numbers, whereby the function applied by the numbering module 1220 is F(x)=4x+1. Therefore, if all of the sequence numbers of the data units are not the same, the total amount of received MPDUs is computed according to the following formula:

(the total amount of MPDUs)=(the sequence number of a last MPDU−the sequence number of a first MPDU)/4+1;

If any two of the sequence numbers of the data units are the same, the total amount of MPDUs is computed according to each of the 0-4095 sections, whereby the amounts of all the 0-4095 sections are added up. Then the FERs of the transmitting device at different transmit rates can be computed accordingly.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A wireless local area network (WLAN) device for transmitting data units, comprising:
a media access control (MAC) layer protocol module for numbering the data units with sequence numbers, wherein each data unit comprises a receiver address and a transmit rate, and the MAC layer protocol module comprises:
a list module for providing the transmit rate of each data unit according to the receiver address of the data unit; and
a numbering module for numbering each data unit with a respective sequence number according to the receiver address and the transmit rate of the data unit.

2. The WLAN device as claimed in claim 1, wherein the data units comprise a MAC management protocol data unit and a MAC service data unit.

3. The WLAN device as claimed in claim 1, wherein the numbering module comprises a counting list module comprising a plurality of counting modules for numbering each data unit with a sequence number.

4. The WLAN device as claimed in claim 3, wherein the numbering module further comprises a first selection module for selecting at least one counting module from the counting list module respectively for each data unit according to the receiver address of the data unit.

5. The WLAN device as claimed in claim 4, wherein the numbering module further comprises a second selection module for selecting one counting module from the at least one counting module selected by the first selection module respectively for each data unit according to the transmit rate of the data unit, wherein the counting module selected by the second selection module is used for numbering the data unit with a sequence number.

6. The WLAN device as claimed in claim 5, wherein the numbering module further comprises a determining module for determining whether the sequence number numbered by the counting module is less than a predetermined threshold value.

7. The WLAN device as claimed in claim 6, wherein the numbering module further comprises a setting module for setting a sequence number to the data unit according to a result of the determination of the determining module.

8. The WLAN device as claimed in claim 1, wherein the MAC layer protocol module further comprises a MAC processing module for generating a plurality of data units, for applying the sequence numbers to the data units, and for adding one or more information fields to the data units to form MAC protocol data units.

9. The WLAN device as claimed in claim 8, further comprising a physical layer protocol module for generating physical layer protocol data units by adding one or more other information fields to the MAC protocol data units.

10. The WLAN device as claimed in claim 1, further comprising a high-level protocol module for providing a plurality of data units.

11. A method for numbering a plurality of frames with sequence numbers, the method implemented in a wireless network having a plurality of data units, wherein the method comprises the steps of:
providing receiver addresses and transmit rates of the data units; and
numbering each data unit with a respective sequence number
according to the receiver address and the transmit rate of the data unit.

12. The method as claimed in claim 11, wherein the data units comprise a media access control (MAC) service data unit and a MAC management protocol data unit.

13. The method as claimed in claim 11, wherein the numbering step comprises:
selecting at least one counting module for numbering each one data unit having different transmit rates with a sequence number according to the receiver address of the data unit;
selecting one of the selected at least one counting module for numbering the data unit with a sequence number according to the transmit rate of the data unit; and
determining whether the sequence number numbered by the counting module is less than a predetermined threshold value; wherein if the sequence number is less than the predetermined threshold value, the sequence number numbered by the counting module is set to the data unit.

14. The method as claimed in claim 13, wherein if the sequence number is not less than the predetermined threshold value, a predetermined sequence number is set to the data unit.

15. The method as claimed in claim 11, further comprising the step of:
applying the sequence number to the data unit.
